(19) United States
(12) Patent Application Publication
(10) Pub. No.: US 2017/0124637 A1
(43) Pub. Date: May 4, 2017

(54) Image Based Purchasing System

(71) Applicants: Norman Ken Ouchi, San Jose, CA (US); Bryan Ken Ouchi, Irvine, CA (US)

(72) Inventors: Norman Ken Ouchi, San Jose, CA (US); Bryan Ken Ouchi, Irvine, CA (US)

(21) Appl. No.: 14/929,263

(22) Filed: Oct. 31, 2015

(51) Int. Cl. G06Q 30/06

(52) U.S. Cl. CPC G06Q 30/0643

(57) ABSTRACT

In the present invention, a user purchases an object viewed in an image with multiple other objects and background. The user sees an object to purchase in an image with other objects, marks the object in the image, and purchases the item by sending the marked image to an object image purchasing system. The object image purchasing system processes the marked image to generate a set of characteristics and searches a database with the characteristics to find purchasable items that match the characteristics. Once a matching item is identified, the purchasable item is returned to the user. The user selects the item and sends the selection to the object image purchasing system which fulfills the request using a prior art fulfillment system.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

The present invention is related to electronic purchasing systems where items are purchased using an image of the object to select the item to purchase.

### BRIEF SUMMARY OF THE INVENTION

In the present invention, a user purchases an object viewed in an image with multiple other objects and background. The user sees an object to purchase in an image with other objects, marks the object in the image, and purchases the item by sending the marked image to an object image purchasing system. The object image purchasing system processes the marked image to generate a set of characteristics and searches a database with the characteristics to find purchasable items that match the characteristics. Once a matching item is identified, the purchasable item is returned to the user. The user selects the item and sends the selection to the object image purchasing system which fulfills the request using a prior art fulfillment system.

### BACKGROUND OF THE INVENTION

A user views images on a computer terminal or other digital viewing device and sees an object that they want to purchase in a digital image. The image of the object is among many other objects in the image and does not provide purchasing information. For example, the image may be one of a child with a toy in an image with children in a playground and the user would like to purchase the toy. Or, an image of a woman with a purse in a photo of her in a park and the user would like to purchase the purse. In the prior art, the user would access an illustrated catalog and look for an item for purchase that matches the toy or purse. The user must manually view the catalog for possible matches. If the object is not found, then other catalogs may be accessed and manually searched. The internet provides the illustrated catalogs of many suppliers. The user may not find an item matching the object after accessing these catalogs even if there are items that match the desired object seen in the image but the appropriate catalog may not have been accessed or the user missed viewing a matching item.

The present invention provides means for a user to identify the image of the object to be purchased and the means to access information based on illustrated catalogs to view an item that may be purchased that matches the image of the object. The user identifies the image of the object in the viewed image using the mouse or other control to mark the area of the image that contains the image of the object to be purchased. The image of the object with in the marked area is sent over a network to an image based purchasing server. The server isolates the image of the object and associates the image to characteristics. A database relating characteristics to items for purchase provides an item with the characteristics of the object. The information to purchase the item is returned to the user. The user can then purchase the item using a prior art fulfillment system.

The image search cannot be photo matching because the object image will often be from a perspective different from that in a catalog and image matching is a computer intensive process that takes many processing steps. The matching process must be more effective by accounting for differences in perspective, scale, lighting, etc. The human eye and mind can match photos but this takes viewing each item in a catalog that have similar descriptions.

The present invention uses unique object characterization algorithms to relate object images to object characteristics where the characteristics are stored in a database where the characteristics are easily queried. Image by image matching is not required. The internet hosts many illustrated catalogs. These are processed to train the object characterization algorithms and then create the catalog of characteristics to purchasable items.

The present invention acknowledges the use of image matching to identity faces in digital photographs and associating known faces with names to faces without names in photos or videos and tagging these faces with names. These processes use image matching where portions of images are found and then matched against prototypes of possible matches.

An article on computer vision by Kristen Grauman University of Texas at Austin Bastian Leibe RWTH Aachen University SYNTHESIS LECTURES ON COMPUTER VISION #1 http://es.gmu.edu/˜kosecka/cs482/grauman-recognition-draft-27-01-11.pdf is included in this disclosure as reference to the prior art image classification processing.

### BRIEF DESCRIPTION OF DRAWINGS

FIG. 1 illustrates a prior art user terminal displaying the image of a boy and toy car.

FIG. 2 illustrates a prior art user terminal where the toy car is marked with a box by the user with a mouse or other graphic control device.

FIG. 3 illustrates a prior art image recognition process where the outline of the object, a toy car, is determined from the image transmitted to an image recognition system.

FIG. 4 illustrates a user terminal and Image Based Purchasing System (IBPS) connected by a network.

FIG. 5 illustrates an object image processing hierarchy with a start node and daughter nodes.

FIG. 6 illustrates the flow chart of processing within an object image processing node.

FIG. 7 illustrates the characteristics tree describing the object to be purchased.

FIG. 8 illustrates the functions within the IBPS.

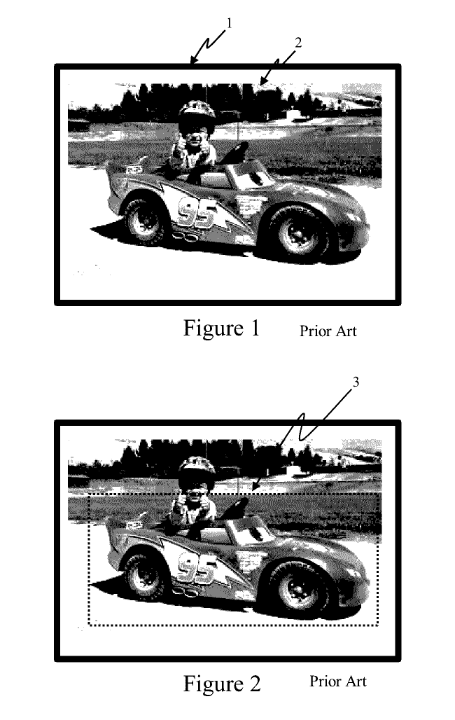

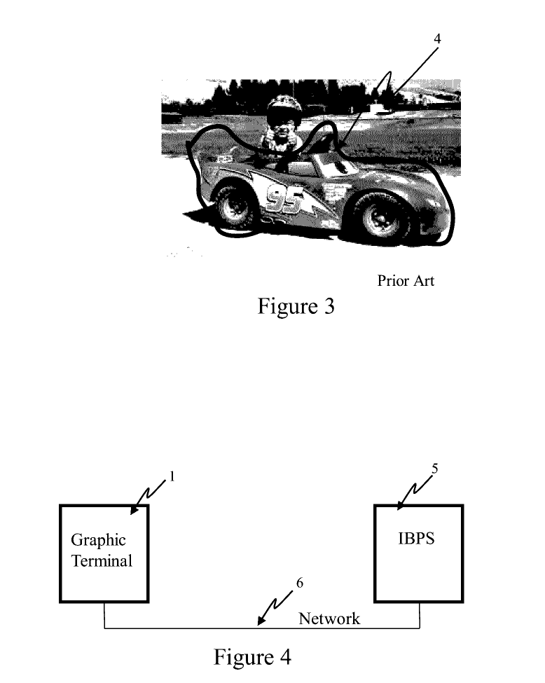

### DESCRIPTION OF THE INVENTION

The present invention has three innovative concepts to implement the purchasing of an item matching an object image selected from an image containing the object image, other objects, and background. The first is a hierarchical image characterization process where the first node of the hierarchy determines the most probable object in a broad classification. There may be more than one classification of the object where the probability of a correct classification is computed in the node. Based on the probable classification, the daughter node or nodes with computed probabilities greater than a preset threshold is selected for the next level of processing. This is described as a Markov probability where the probability is dependent on the state or node in the hierarchy. Biological vision systems use a similar object resolution process where the most probable object is visualized and further details are resolved to determine if the assumption is correct. As the object is further resolved, the visual object may change to another. A person can experience this when seeing an object in dim light where something looks like one object and is seen as another when the object is further resolved. Optical illusions use this function of biological visual system where a drawing can be viewed as one of two very different objects. The visualized objects may flip back and forth when viewed. The second concept is computing characteristics from the image that are stored in a database. Two similar objects have similar characteristics. This permits matching of an object to a purchasable item by query of a database rather than image matching. The characteristics are structured in a hierarchy derived from the object characterization process hierarchy. The query is hierarchical where the characteristics from the first node are queried first and subsequent daughter node characteristics are queried. The query process completes when a terminal node with a purchasable item is returned or no items are returned. The third concept is training the classification algorithms using a prior art catalog of purchasable items with images. Once the algorithms are trained, the catalog is processed and the items in the catalog have characteristics stored in the database that is then queried with the characteristics of a user selected object to purchase.

The present invention is comprised of a prior art user terminal 1 to display images and videos and an image based purchasing server (IBPS) 5 where both are connected by a network 6. The user views images and videos containing a variety of objects including people, landscapes, and items on the user terminal 1. A video is paused to display a static image. The user sees an object in an image 2 that they would like to purchase. Using a mouse or other graphic control tool, the user marks the image of the object in the viewed image. The prior art teaches the use of a mouse to draw a box 3 around an object to isolate the pixels of an object image. The user terminal sends the image of the box with the object to the IBPS 5 using well known prior art applications and protocols.

The image based purchasing system (IBPS) 5 processes the image to relate it to a set of characteristics that classify the item in the image. The IBPS 5 provides a database 16 of processed images from illustrated catalogs where characteristics for each image are stored in searchable format with the image of the item, description, price, and other purchasing information. The IBPS 5 queries the database 16 with the characteristics of the transmitted image. The database 16 responds with the item or items that meet the characteristics. The IBPS 5 returns the item image, description, and purchasing information to the user terminal 1 where these are displayed for the user.

In terminal 1, the user selects an item for purchase and transmits the selection to the IBPS 5.

The IBPS 5 uses the selection information to fulfill the purchase request in a prior art purchasing system 17. The prior art purchasing system 17 is provided the name of the user, delivery address, payment information and the functions are well known in prior art. The IBPS 5 transmits a confirmation of the purchase to the user terminal 1. The prior art purchasing system 17 fulfills the purchase request.

Prior Art Image Trimming

The object image is contained in the outlined image transmitted by the user terminal 1. The outlined image 2 contains the object image and fragments of other images of the background. In the prior art, the object image is trimmed from the background using well known algorithms. The trimmed image provides the object image and the boundaries for the image processing. However, the image trimming may lose details necessary for accurate object characteristics generation. The present invention integrates the image isolation into the object image processing.

Object Image Processor 15 and Database 16

The object image processor 15 computes or generates from a marked object image 3 a set of characteristics 11 that are used to define the object. Purchasable items in the fulfillment system 17 catalog are pre-processed to generate characteristics 11 for each item. The item information and characteristics 11 are stored in a prior art database 16. The object characteristics 11 are used to search the database16 for purchasable items with characteristics matching the object characteristics 11.

Object Image Processor 15

Hierarchy Tree with Calculated Probabilities

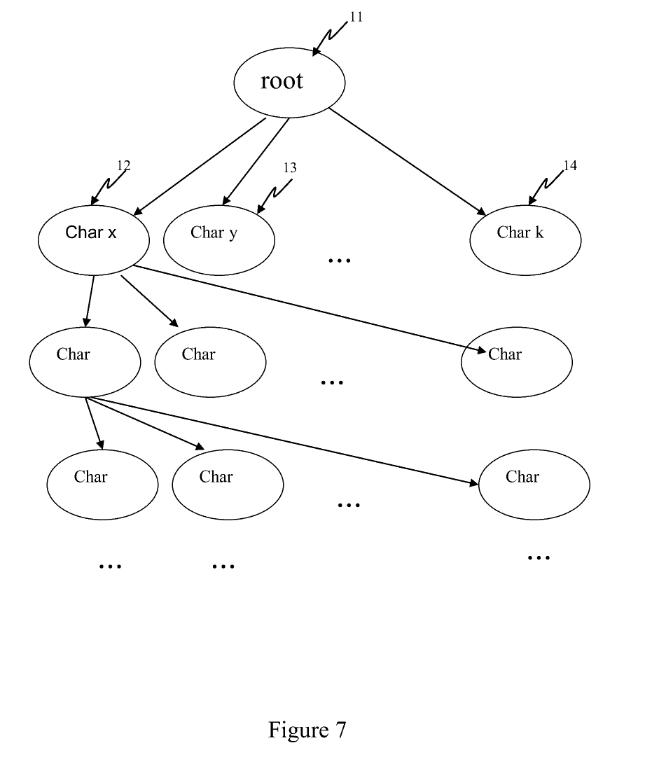

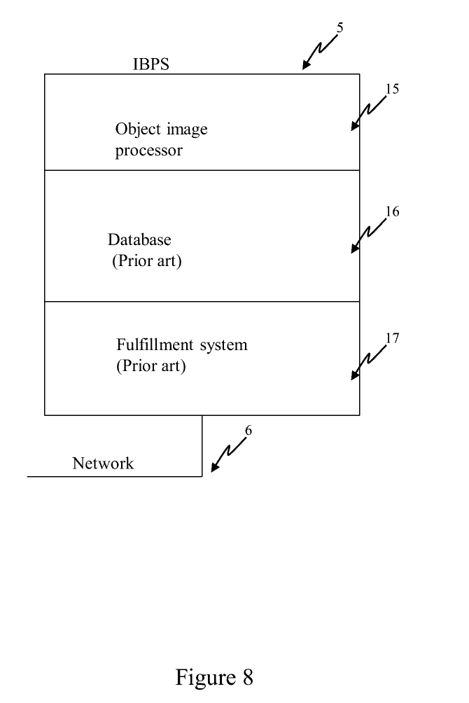

The object image processor 15 uses a hierarchy of processes 7 to generate the characteristics. The hierarchy is represented as a tree structure where each node in the tree provides branches based on the result of the processes at the node. Subsequent nodes use the fact that it is executing because of the sequence of prior nodes have detected features and clusters of features that determined that that node is part of the probable classification of the object. At each node, the process provides a set of feature detectors, cluster generators, branch probability generators, and characteristic generators. As a result of the training, the sets are unique to the node. The feature detectors have smaller resolution than prior art feature detectors so that the feature size and scaling are not issues. The cluster generators account for affinity among the features such that for example, features that define a wheel and tire are resolved independent of scale or incomplete set of detected features. Hence, prior art feature detectors that would miss smaller or incomplete features in the object are detected by the smaller feature detectors and cluster generators of the present invention. The tree structure is implemented in a prior art database as illustrated in FIG. 7. Each branch has a probability that the selection of the branch is correct and leads to a daughter node with processes.

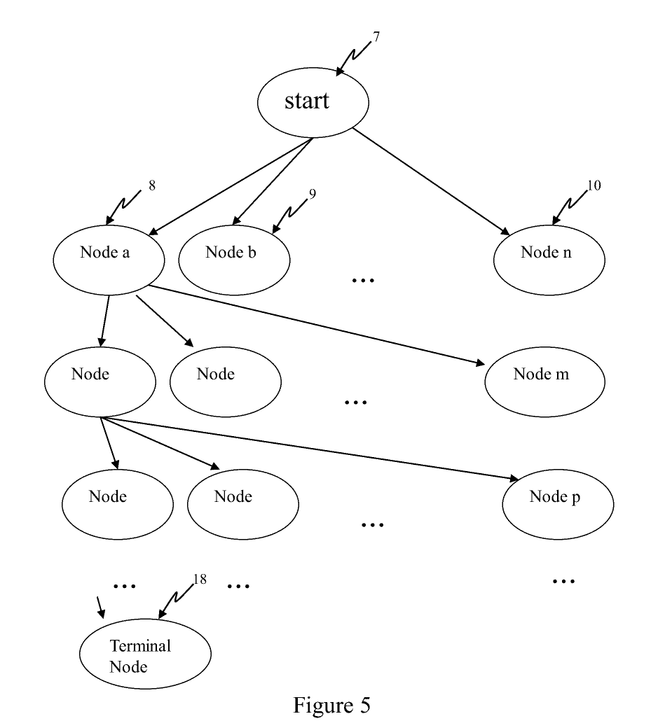

The hierarchy can be described as a Markov tree where the probabilities of each branch are calculated by processes defined for the node. A branch with a probability greater than a preset threshold indicates the branch worth pursuing and the daughter node is processed. More than one branch may be taken. When no branch has a probability greater that the threshold, the process for that sequence of nodes terminates. The terminal node 18 indicates that the object has been classified completing the processing for that sequence of nodes. Node processing is parallel and other node sequences can continue processing after a sequence of nodes has completed. The character generation is complete when all sequences have completed. Each node processed provides characteristics based on the processing results. The characteristics for an object are the hierarchy of characteristic for each node that was processed. Illustrated in FIG. 5, the processing begins at the start node 7 and proceeds down the hierarchy taking all branches with computed probabilities above the threshold, node a 8, node b 9, . . . node n 10. The hierarchy continues to the terminal nodes 18. The characteristics for a terminal node 18 are the hierarch of characteristics beginning with root 11 generated at each node beginning at the start node 7 to the terminal node 18 and stored as a hierarchy as illustrated in FIG. 7. The root 11 has the characteristics generated in the start node 7 and the subsequent char x 12, char y 13 . . . char k 14 are the characteristics generated as the processing proceeds in the processing hierarchy. Two objects that are similar generate similar characteristics.

As an example, the start node 7 determines the gross characteristics. E.g., the object is wheeled or a rectangle without wheels or . . . . When a wheel like cluster is computed, the wheeled object daughter node has a high probability while the rectangle without wheels has a low computed probability. The wheeled object daughter node has feature detectors, cluster organizers, etc. to further determine further a wheeled object. The daughter node for a rectangle without wheels would have feature detectors, etc. that do not further resolve wheels.

Process Steps at a Node.

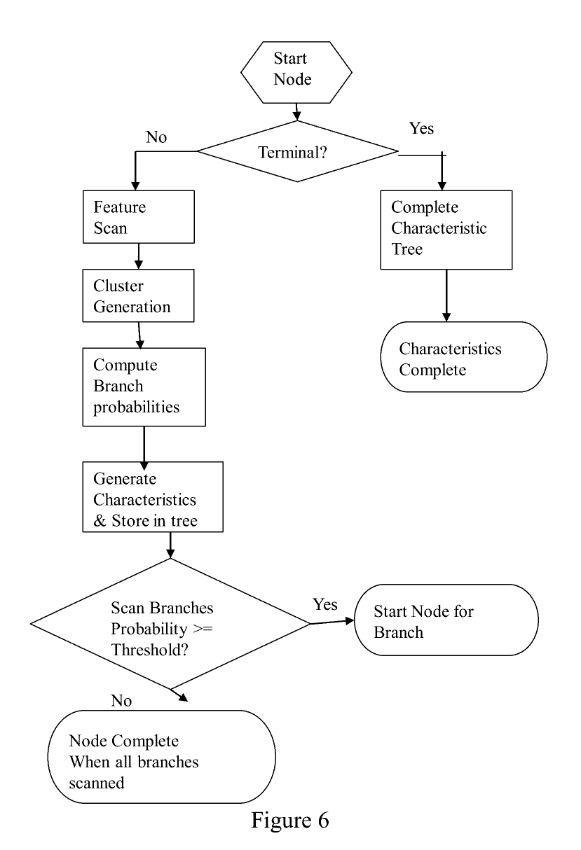

The flow chart for the processing at each node is illustrated in FIG. 6. Each node provides a set of feature detectors, a collection of pixels that identify a feature by matching pixels in the image with the detector. The object image 3 is scanned with feature detectors to identify the classification of the object in the object image. Feature detectors determine if a specific feature is in the object image and the location of the feature. Feature detectors are assigned identifiers, feature locations are the relative x and y location values. Feature detectors are created and evolve with learning. Feature detectors have affinity to other feature detectors that may be detecting a feature as defined in the prior art. That is, for example, features that comprise a wheel and tire have an affinity to each other, rather than affinity with feature detectors for elements of a purse or even a fender or window. These may be represented as n-dimensional arrays where the values represent the level of affinity among n feature detectors. The affinity arrays are specific to a node so the relationship between feature detectors are different for each node. Nodes that are resolving a car are different for a node leading to the resolution of a purse. Clusters are groups of features where the cluster generator algorithms are for a node and created and evolve during the learning phase. Cluster generator algorithms are specific to a node where the affinity array is a factor of how the features are clustered for a node. Clusters are assigned identifiers or types that can be stored in a prior art database as text or numeric values.

Detected features and their locations are characteristics of the object image. Detected features are grouped into clusters. The feature clusters and their locations are also characteristics. The feature locations and clusters are normalized to account for different image scaling. Features are organized in the hierarchy where features common to a group of similar objects identify the group and features specific to a member of a group are used to identify a specific item in a group. For example a set of feature clusters identify an object as a car rather than a purse or other object. An example is a cluster of features and dimensions that identify a wheel. The cluster of features detect a wheel even if parts of the wheel are obscured or the wheel is viewed from an angle. Wheel clusters and other identifying clusters classify the object as some sort of car. The wheel clusters are used to determine the orientation of the car so the subsequent features and clusters are consistent with this orientation. Based on this classification the car branch has a high computed probability and is taken in the hierarchy tree and features at the daughter node are then used to identify a specific car body type, SUV, coupe, sedan, etc. Clusters for doors, fenders, head lamps, identify these features. The branch based on body type provides a node with a set of feature clusters identify a specific manufacturer of that car body type. And further tree branches provide set of feature clusters identify a specific model year of a specific manufacturer of that car body type. The hierarchy of feature clusters provides characteristics that identify an object.

Training

The tree of feature hierarchy process is adaptable and generated by training on known items in prior art illustrated catalogs and stored in a searchable database.

In the training mode, the characteristics of an item are stored in a searchable database along with the description of the item, price, image, and other ordering information.

Using deep learning, feature detectors, affinity arrays, and cluster detectors and cluster generating algorithms evolve by changing to generate characteristics that are consistent for the same or similar objects. The programs are written for learning and the elements evolve with the learning. Feature detectors can learn by modifying an existing feature detector or by copying and modifying one of the copies. Learning generates and evolves the relationship defining affinity arrays between feature detectors. Learning also occurs in the generation of probabilities. Learning occurs in the clustering algorithms by changing affinity arrays and other elements of the algorithms.

The object image processor develops the processes using deep learning where parameters and classification arrays are evolved by training the object image processor on a large set of representative data. In the present invention, the object image processor is trained on the illustrated catalog of a prior art fulfillment system. The prior art catalog provides descriptive text that can be used for supervised learning so that similar items can be grouped and the object image processor learn to group these items. The object image processor can use feature detection to determine the characteristics. Feature geometry and feature clusters are other characteristics. The object image processor learns so that similar items will have similar characteristics.

Object Image Searching

The object image 3 is processed to generate the characteristics of the object. These characteristics are used to search the database16 to determine which items have characteristics matching the requested item. The characteristics are stored in hierarchies similar to the feature cluster hierarchies. The characteristics for a toy car may be very different from those for a purse and a flat relational database would not be suitable to store the item characteristics. However, even as a hierarchy, the characteristics are easier to search compared to searching images since the features and clusters are represented by text strings or numeric values and not image fragments. Searching traverses the characteristics tree using the hierarchy of characteristics derived for the object. The terminal nodes 18 of the characteristic tree are the purchasable items. Multiple terminal nodes 18 may be found and multiple items are sent to the user terminal 1 as the result.

Purchasing an Item

The search of the database 16 may result in a terminal node with a purchasable item. The item image and purchasing information, e,g, price, item identifier, description, etc., are transmitted to the user terminal 1. The user selects the item for purchase and sends the selection back to the IBPS 5. The IBPS 5 initiates an order fulfillment including delivery in a prior art purchasing system 17. The structures for storing user delivery address, payment method and approval, etc. and algorithms for a fulfillment system 17 are well known and not described in this disclosure.

Scaling

The object image may not have scaling information. The object image 3 may be of a real car and the IBPS 5 may return a model car. The user may have wanted a real car or a toy car. The scaling of the object image 3 is an added function as an input from the user.

### Rotation or Changing Object Perspective

The object image 3 may illustrate the object at an angle where the feature detectors cannot determine characteristic of the object. The user has a function that effectively rotates the object image by stretching image to aid the object processor to determine the characteristics. The effect of rotation is done by scaling the image in one of the dimensions if the image has only two dimensions and not a rotatable 3D model.

Training with user Assistance

The object processor 15 may return erroneous results. The user provides feedback to the object processor 15 by indicating item images that are closer to the object image 3 as perceived by the user. The object image processor 15 learns from this response and modifies the object characteristic generation or the feature search or the clusters or the hierarchy to improve the object image processing. The user may input the classification of the object to aid in learning.

### Summary

The user indicates an object in a digital image using a cursor, mouse, or graphic control at the user terminal 1 and sends the object image 4 to the IBPS 5. The IBPS 5 uses the object image processor 15 to generate a hierarchy of characteristics 11. A database 16 of purchasable items with generated characteristics is searched to find items with similar characteristics to those of the object. Purchasing information including the item image for those items that were found are transmitted to the user terminal 1. The user selects an item for purchase and transmits the choice to the IBPS 5. The IBPS 5 generates a purchase request for the item in a prior art fulfillment system 17 and transmits a response to the user terminal 1. The item purchase is fulfilled by the fulfillment system 17.

### Description of a Preferred Embodiment

The item image based purchasing system is comprised of a user terminal 1 and an Image Base Purchasing System (IBPS) 5 connected by a network 6 as illustrated in FIG. 4.

### User Terminal 1

The user terminal 1 may be implemented using one of many commercial devices as an IBM compatible PC, Apple iPad, iPhone, or Mac, or similar devices. The software may be implemented using a commercially available graphics application or web browser capable of displaying images 2, selecting an area of an image using a cursor or mouse 3 to outline an object in the image and transmitting the outlined image to the IBPS 5 over a network 6. The software also provides accepting a response from the IBPS 5 including text and images; displaying the response, accepting a selection by a user, and sending the selection to the IBPS 5.

### IBPS 5

The IBPS 5 is implemented as an array of general purpose processors (GPP) and an array of graphic processing units (GPU). The GPP are processors as provided by Intel, IBM, or other commercially available devices. The array of GPP provide the network connections and supervisory processes. The GPU are special purpose processors for graphic processing such as video games, computer aided design, or computer generated images for movies and provided by Nvidia or other game console or massively parallel processor providers. The software for the GPP includes a prior art relational database 16 to implement the hierarchy tree and the characteristics trees and a graphic server as a network and web server. The object image processing 15 may be implemented as deep learning neural networks where the logic is implemented for the GPP and the feature scanning is implemented for the GPU. The neural network is trained on commercially available illustrated catalogs such as those provided by Amazon and many other commercial web stores. The purchase request is fulfilled by transmitting the purchase request to Amazon or commercial web store, prior art fulfillment system 17.

### Network 6

The network may be the internet or other commercially available networks that support transactions including graphics. The network may be wired or wireless.

We claim:

1. An image based purchasing system comprising:
a user terminal and an image based purchasing server (IBPS) both connected by a network where:
the user terminal provides for a user:
means to display an image;
means to mark an object image in the image;
means to transmit the marked object image to the IBPS;
means to receive a response from the IBPS and display the response contents including:
item identifier, item price, item image of a purchasable item;
means to transmit a purchase request including the item identifier to the IBPS;
means to receive a purchased response from the IBPS;
the IBPS provides:
an object image processor means that generates the object characteristics of a marked object image;
a database means providing a query including object characteristics as an argument and returns as a response: item identifier, item price, item image of a purchasable item matching the object characteristics;
an order fulfillment means fulfilling the purchase of an item using the item identifier;
means to receive the marked object image from the user terminal and generate object characteristics using the object image processor means;
means to query the database means with object characteristics and receive the response including the item identifier, item price, and item image of the purchasable item;
means to transmit the item identifier, item price, and item image of the purchasable item to the user terminal;
means to receive a purchase request including an item identifier from the user terminal;
means to fulfill the purchase using the order fulfillment means using the item identifier and send a purchased response to the user terminal.

2. The order fulfillment means of claim 1 further provides means for an illustrated catalog of purchasable items and the object image processor is trained using the illustrated catalog.

3. The terminal of claim 1 further provides a means for the user to indicate the scale of the object in the object image and transmit the scale to the IBPS and the IBPS further provides means to accept a scale of the object image to determine the characteristics of the object.

4. The terminal of claim 1 further provides means to rotate the object image and transmit the rotated image to the IBPS.

5. The terminal of claim 1 further provides means for user feedback to an IBPS response of a purchasable item and means to transmit the feedback to the IBPS and the IBPS further provides means to accept the feedback and modify the object image processor.

6. The object image processor means of claim 1 further provides means for scanning the object image using feature detectors where the feature detectors have affinity values relating to other feature detectors; means to cluster detected features using the affinity values; means to compute branch probabilities; means to generate characteristics and store the characteristics as the object characteristics.

7. The object image processor means of claim 1 further provides a hierarchy of nodes connected by branches where each node provides scanning of the object image with feature detectors, clustering of detected features, computing of probabilities for each branch, and generation and storing of characteristics as the image characteristics and the computed probability for a branch higher than a threshold value is used to activate the daughter node.

8. The item image processor means of claim 1 further provides for storing characteristics in a hierarchy as the image characteristics.

9. An object image based purchasing system comprising a user terminal and image based purchasing server (IBPS) both connected by a network where:
the user terminal provides for a user:
means to display an image;
means to mark an object image in the image;
means to transmit the marked object image to the IBPS;
means to receive a response from the IBPS and display the response contents including: item identifier, item price, item image of a purchasable item;
means to transmit a purchase request including the item identifier to the IBPS;
means to receive a purchased response from the IBPS;
the IBPS provides:
means to receive the marked object image from the user terminal and respond with an item identifier, item price, item image of a purchasable item matching the marked object image;
means to receive a purchase request including item identifier from the user terminal, fulfill the purchase request, and send a purchased response.

10. The IBPS of claim 9 further provides means for an illustrated catalog of purchasable items and the IBPS is adaptable and trained using the illustrated catalog.

11. The user terminal of claim 9 further provides means for user feedback to an IBPS response with a purchasable item and the IBPS further provides means to accept feedback and modify the matching of object image to purchasable item.

12. The user terminal of claim 9 further provides means to rotate the object image and send the rotated object image to the IBPS.

13. The user terminal of claim 9 further provides means to send the scale of the object image to the IBPS and the IBPS further provides means accept the scale and modify the matching of object image to purchasable item.

14. A method for a user to purchase an item matching an object image viewed with other objects in an image on a user terminal connected by a network to an image based purchasing server (IBPS) comprising the steps of:
the user marks the object image in the user terminal and sends the marked object image to the IBPS;
the IBPS responds to the user terminal with a purchasable item matching the marked object image where the response includes an item identifier and price;
the user selects the purchasable item on the user terminal and sends the selection to the IBPS;
the IBPS fulfills the purchase request and sends a purchased response to the user terminal.

15. The method of claim 14 where the IBPS further provides an illustrated catalog and the IBPS is adaptable and trained on the illustrated catalog.

16. The method of claim 14 where the user terminal further provides feedback from the user to the IBPS on the purchasable item response and the IBPS receives the feedback and adapts the IBPS matching function.

17. The method of claim 14 where the user terminal further provides a scale of the object image and the user sends the scale to the IBPS and the IBPS receives the scale and adapts the IBPS matching function.

18. The method of claim 14 where the user terminal further provides rotating the object image and the user sends the rotated object image to the IBPS.
